(19) United States
(12) Patent Application Publication
(10) Pub. No.: US 2005/0126297 A1
(43) Pub. Date: Jun. 16, 2005

(54) Pressure sensor element having an integrated sealing surface

(76) Inventors: Thomas Moelkner, Stuttgart (DE); Holger Scholzen, Stuttgart (DE); Joerg Gebers, Hemmingen (DE); Ralf Kaiser, Unterbrueden (DE); Carsten Kaschube, Nuertingen (DE); Christian Roesser, Grossbottwar-Winzerhausen (DE); Lothar Baumann, Wernau (DE); Hans-Peter Didra, Kusterdingen-Jettenburg (DE); Roger Frehoff, Gerlingen (DE); Markus Fissler, Tamm (DE); Markus Ledermann, Asperg (DE); Benjamin Thiel, Stuttgart (DE)

Correspondence Address: KENYON & KENYON, ONE BROADWAY, NEW YORK, NY, 10004, US

(21) Appl. No.: 10/891,819

(22) Filed: Jul. 15, 2004

(30) Foreign Application Priority Data
Jul. 16, 2003 (DE) 103 32 284.1

(51) Int. Cl. G01L 7/08

(52) U.S. Cl. 73/715

(57) ABSTRACT

The present invention relates to a sensor element for detecting pressures or forces. The sensor element (10) includes a sensor diaphragm (13), on the diaphragm outer side (20) of which piezoresistive measuring elements (8) are located. The sensor diaphragm (13) of the sensor element (10) is diametrically opposed to a sealing surface (15, 16) for sealing off the sensor element (10) from a housing. A force introduction region (23, 24) for introducing a force which produces a seal is mechanically decoupled from the sensor diaphragm (13) of the sensor element (10).

### TECHNICAL AREA

Pressures or forces are often measured using piezoresistive sensor elements. These sensor elements utilize the deformation of a surface by forces and/or pressures acting on this surface as the measuring effect. For this reason, it is necessary to decouple deformations from the sensor element which are not related to the pressure to be measured, such as installation-related stresses and thermal expansions.

### BACKGROUND INFORMATION

Publication DE 38 11 311 C1 relates to a pressure sensor for detecting pressure in the combustion chamber of internal combustion engines. The housing of the pressure sensor is closed off from the combustion chamber via a pressure-sensitive diaphragm. A rod is joined at its first end with the pressure-sensitive diaphragm, and its second end rests against at least one piezoelectric crystal. The transmission of force to the at least one piezoelectric crystal takes place via gapless material bonding without mechanical preload. The connection of the diaphragm with the housing is formed by a welded joint, whereby all boundary surfaces of the components following the second end of the rod are joined with the aid of an adhesive connection.

Publication DE 40 22 783 A1 also relates to a pressure sensor for detecting pressure in the combustion chamber of internal combustion engines. A hybrid is composed of a piezoelectric material. The electronic components of an electrical evaluation circuit are located on the hybrid. Furthermore, contact surfaces are imprinted on the hybrid. The hybrid is located directly between a rod and a counter-bearing of a pressure sensor. The electronic components and the contact surfaces are joined with the aid of simple standard bonding wires. As a result, the pressure sensor according to DE 40 22 783 A1 is particularly compact.

Publication DE 195 38 854 C1 also relates to a pressure sensor for detecting pressure in the combustion chamber of internal combustion engines. A rod is located in a bore of a housing, the rod resting with one end against a diaphragm which closes off the opening of the bore. With one end, the rod acts on the measuring element, producing a measuring signal that is proportional to the pressure in the combustion chamber. The shape of the rod, the surface of the end of the rod and the measuring element, and the particular materials are matched with each other such that a nearly error-free introduction of pressure is possible.

Publication DE 44 19 138 A1 relates to a high-temperature pressure sensor, in the case of which deflection is induced within a diaphragm section when the pressure of a high-temperature fluid acts on the compression spring surface of the diaphragm section. The deflection is transferred via pressure transmission parts to a deflection detection part that generates an electrical signal in response to the pressure received. The diaphragm section has a recessed section in its center. The recessed section extends symmetrically around a central axis of the diaphragm section. One end of the pressure transmission part is brought in contact with the recessed section at a central point. A conical section in the diaphragm has a thickness that is not greater than the thickness of an exterior circumferential section or the thickness of a central base section. A thermal insulation panel can be provided on the diaphragm to protect the surface of the diaphragm section from the thermal radiation of the high-temperature fluid.

Piezoresistive sensor elements that are used to detect pressures and forces utilize the deformation induced by the acting forces and/or pressures as the measuring effect. For this reason, the deformations of the sensor element that can occur when it is installed, for instance, must be kept to a minimum. For this reason, the fixing thread of a sensor and its sealing surface must be located as far away from the sensor element as possible and be mechanically decoupled therefrom to the greatest extent possible.

### ADVANTAGES OF THE INVENTION

In the embodiment of a sensor element having an integrated sealing surface proposed according to the present invention, a particularly compact sensor that performs many functions using one component is realized. One advantage of the sensor proposed according to the present invention is that it enables pressure detection while also permitting the pressure sensor to be sealed off from the pressurized measuring medium with the housing into which the sensor element having an integrated sealing surface proposed according to the present invention is screwed. The pressure measuring function and the sealing function are achieved by one and the same sensor element, and it is ensured that the sealing function does not negatively affect the pressure measuring function via deformation of the sensor element.

The integrated sealing surface allows the sensor element to be markedly reduced in size in terms of the overall size of the entire sensor. It is further possible to move the sensor diaphragm close to the measuring volume, even in very cramped installation conditions, which is not easily possible with the sensors having piezoresistive measuring elements known from the related art.

### DRAWING

The invention will be described in greater detail below with reference to the drawing.

FIG. 1 shows a section through a welded sensor element known from the related art,

FIG. 2 shows a top view of the sensor element known from the related art according to the depiction in FIG. 1,

FIG. 3 shows a perspective view of the sensor element proposed according to the present invention, and

FIG. 4 shows a cross section through the sensor element proposed according to the present invention, according to the depiction in FIG. 3.

### DESCRIPTION OF THE EXEMPLARY EMBODIMENTS

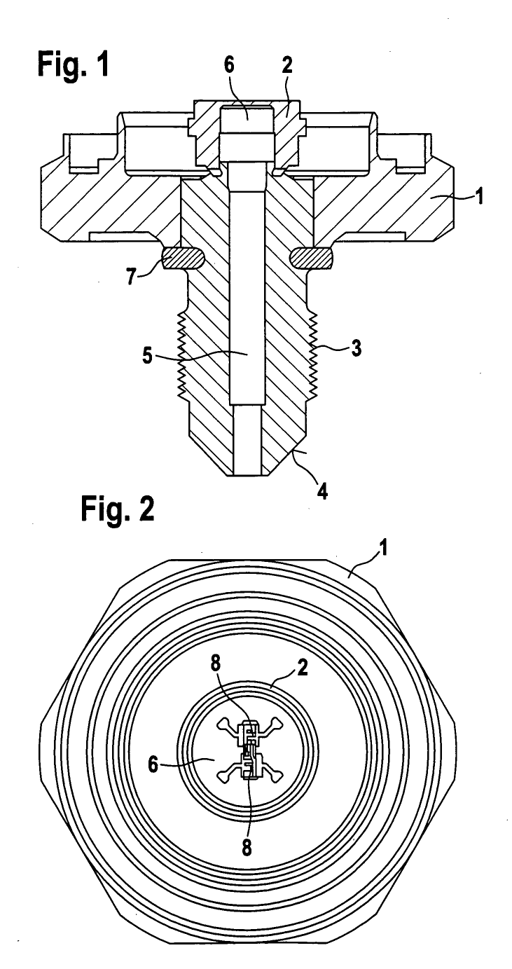

The depiction according to FIG. 1 shows a sensor element known from the related art.

The sensor element shown in FIG. 1 includes a sensor body 1 on which a piezoresistive pressure sensor element 2 is mounted. Sensor body 1 is welded via a weld 7 with a plug on which a fixing thread 3 is formed, the fixing thread being spatially separated from sensor body 1. A sealing cone 4 is located on the lower end of the plug, below fixing thread 3. The plug has a through-bore 5 extending through it, the through-bore being closed off by a sensor diaphragm 6 of piezoresistive pressure sensor element 2. The pressure sensor known from the related art and shown in FIG. 1 has a relatively great overall height in order to mechanically decouple sealing cone 4—into which the sealing forces are introduced—from sensor body 1.

FIG. 2 shows a top view of the sensor element according to the depiction in FIG. 1 and known from the related art.

In the top view according to FIG. 2, it is clear that a plurality of piezoresistive measuring elements 8 are installed on the top side of sensor diaphragm 6 of piezoresistive pressure sensor element 2. When through-bore 5 (refer to FIG. 1) is acted upon with pressure, sensor diaphragm 6 is deformed. The pressure acts on piezoresistive measuring elements 8 mounted on the top side of sensor diaphragm 6 and a signal corresponding to the pressure is produced.

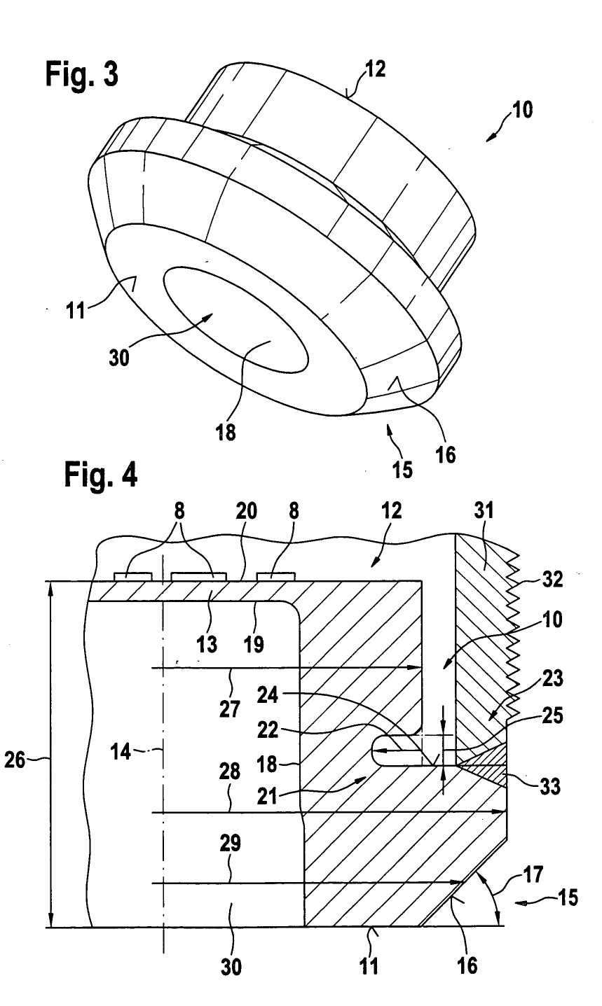

The depiction according to FIG. 3 is a perspective view of the sensor element having an integrated sealing surface designed according to the present invention.

A sensor element 10 having an integrated sealing surface has a first end face 11 and a second end face 12. First end face 11 includes an opening from which a hollow space 30 extends to act upon a sensor diaphragm (not shown in FIG. 3) provided at second end face 12. Hollow space 30 is limited by an inner wall 18 of sensor element 10. A sealing cone 15 is formed on first end face 11 of sensor element 10 having an integrated sealing surface. Sealing cone 15 is formed by a sealing surface 16 that extends in the shape of a cone, starting from first end face 11 in the direction of second end face 12 of sensor element 10 having an integrated sealing surface.

The depiction according to FIG. 4 is a cross section through the sensor element having an integrated sealing surface according to the present invention and shown in FIG. 3 in a perspective view.

Sensor element 10 having an integrated sealing surface is a rotationally symmetrical component having a symmetrical configuration relative to axis of symmetry 14. According to the depiction in FIG. 4, sealing cone 15—starting at first end face 11 of the sensor element—is formed directly on the sensor body of sensor element 10. The slant, the cone angle with which sealing surface 16 of sealing cone 15 extends relative to first end face 11 of the sensor element, is labeled with reference numeral 17. Cone angle 17 is preferably in the range from 30° to 60°. Hollow space 30, limited by inner wall 18, of sensor element 10 having an integrated sealing surface according to the depiction in FIG. 4 is limited by sensor diaphragm 13. A diaphragm inner side 19 faces hollow space 30, while a diaphragm outer side 20 is second end face 12 of sensor element 10 having an integrated sealing surface. Piezoresistive measuring elements 8 are located on the top of membrane outer side 20.

A decoupling groove 21 extending in the direction of inner wall 18 of sensor element 10 is provided above a force introduction region 23 on the outside of sensor element 10 according to the depiction in FIG. 4. Sensor element 10 having an integrated sealing surface includes an annular surface 24 in force introduction region 23. The sensor element may be welded with a tubular sleeve at this annular surface in the circumferential direction, for example, via which the necessary forces may be introduced to achieve a seal in the region of sealing cone 15. Sealing surface 16 of sealing cone 15 is designed such that only minimal moment which may deform sensor membrane 13 is produced by the sealing forces introduced via annular surface 24 in force introduction region 23.

By forming decoupling groove 21 with a groove depth 22, the deformations in the lower region of sensor element 10, i.e., below decoupling groove 21, are not transmitted to the upper region toward sensor diaphragm 13 equipped with piezoresistive measuring elements 8. Decoupling groove 21 is formed with a groove depth 22 and a groove width 25. To ensure the best possible mechanical decoupling of force introduction region 23 from the region in which piezoresistive measuring elements 8 of sensor element 10 having an integrated sealing surface 16 are located, groove depth 22 is configured with the largest possible groove depth 22 and the largest possible groove width 25. The design of groove depth 22 and groove width 25 is optimized in an individualized manner, so that both the mechanical stability of sensor element 10 having an integrated sealing surface 16 against the pressure inside hollow space 30 and the starting torque required to screw in sensor element 10 having an integrated sealing surface are still ensured.

Sensor element 10 having an integrated sealing surface according to the present invention has a first diameter 27 in its upper region according to the depiction in FIG. 4. The maximum diameter of sensor element 10 having an integrated sealing surface is labeled with reference numeral 28 and is located in the region where sealing surface 16 of sealing cone 15 phases out. The mean diameter of sealing surface 16 is labeled with reference numeral 29. In comparison with the sectional view of a sensor element known from the related art shown in FIG. 1, the sensor element having an integrated sealing surface proposed according to the present invention has a substantially smaller overall height 26. By integrating sealing surface 16 of sealing cone 15 in the body of sensor element 10, the overall size of the sensor arrangement proposed according to the present invention may be markedly reduced, and its sensor diaphragm 13 may be moved close to the measuring volume, even in cramped installation conditions. This is unattainable with the embodiment of a sensor element from the related art shown in FIG. 1 due to the large distance between sensor diaphragm 6 and sealing surface 4. Sealing cone 4 of the sensor element known from the related art is located far behind diaphragm 6 and is separated therefrom by the overall length of the plug-shaped body.

Instead of decoupling groove 21 having a rounded cross section as shown in FIG. 4, other decoupling geometries may be formed between force introduction region 23 for generating the sealing force and sensor diaphragm 13 on second end face 12 of sensor element 10 having an integrated sealing surface. Instead of decoupling groove 21 having a U-shaped profile shown in FIG. 4, it could also have a semi-cylindrical groove base, or it could be configured in the shape of a slot. The geometry of decoupling groove 21 with regard to groove depth 22 and groove width 25 varies depending on the materials used and on the installation space available for sensor element 10 having an integrated sealing surface proposed according to the present invention. To obtain an optimal mechanical decoupling of sealing cone 15 at first end face 11 of sensor element 10 and sensor diaphragm 13 formed on second end face 12 of sensor element 10, decoupling groove 21 is located as centrally as possible between first end face 11 and second end face 12. Sensor element 10 having an integrated sealing surface proposed according to the present invention, according to FIGS. 3 and 4, ensures that the functions of pressure measurement¹ and sealing the pressure sensor off from the housing into which it is screwed are performed using one and the same component.
¹ Translator's Note: The German states: “the functions of pressure, measurement . . . ”

Using a sensor tubular sleeve 31, sensor element 10 having an integrated sealing surface 16 is located in the cylinder head of an internal combustion engine in the vicinity of the combustion chamber, for example. Sensor tubular sleeve 31 contacts, with one end face, annular surface 24 at force introduction region 23. The end face of sensor tubular sleeve 31 facing annular surface 24 may also be connected to annular surface 24 via a bonded connection 33 indicated in FIG. 4. When sensor tubular sleeve 31—which has a threaded section 32—is screwed in, sensor element 10 having an integrated sealing surface 16 is accommodated in the cylinder head of an internal combustion engine, creating a seal at sealing cone 15. Decoupling groove 21 ensures that sensor diaphragm 13—on membrane outer side 20 of which piezoresistive measuring elements 8 are located—is insulated from installation-related stresses that may have a negative effect on the measurement result.

Sensor element 10 having an integrated sealing surface 16 depicted in FIG. 4 may be made of stainless steel, for example, and have a diameter of nearly 5 mm. Sensor element 10 having an integrated sealing surface proposed according to the present invention may also be fabricated with a diameter of 8.6 mm and greater, for example.

### Reference Numerals

1 Sensor body
2 Piezoresistive pressure sensor element
3 Fixing thread
4 Sealing cone
5 Through-bore
6 Sensor diaphragm
7 Weld
8 Piezoresistive measuring elements
10 Sensor element having an integrated sealing surface
11 First end face
12 Second end face
13 Sensor diaphragm
14 Axis of symmetry
15 Sealing cone
16 Sealing surface
17 Cone angle
18 Inner wall
19 Membrane inner side
20 Membrane outer side
21 Decoupling groove
22 Groove depth
23 Force introduction region
24 Annular surface
25 Groove width
26 Overall height of sensor element
27 First diameter
28 Maximum diameter
29 Mean diameter of sealing cone
30 Hollow space having a measuring volume
31 Sensor tubular sleeve
32 Threaded section
33 Bonded connection

1. A sensor element for detecting pressures or forces, having a sensor diaphragm (13) at whose diaphragm outer side (20) piezoresistive measuring elements (8) are located, and diametrically opposed to which a sealing surface (15, 16) is located for sealing the sensor element (10) from a housing,
wherein a force introduction region (23, 24) for introducing a sealing force is mechanically decoupled from the sensor diaphragm (13).

2. The sensor element as recited in claim 1,
wherein a decoupling groove (21) is provided on the circumference of the sensor element between the force introduction region (23, 24) and the sensor diaphragm (13).

3. The sensor element as recited in claim 1,
wherein the body of the sensor element (10) has a sealing cone (15) whose sealing surface (16) extends at a cone angle (17) between 30° and 600.

4. The sensor element as recited in claim 3,
wherein the sealing cone (15), starting from a first end face (11), is mounted in a region of the sensor element (10) where it has its maximum diameter (28).

5. The sensor element as recited in claim 2,
wherein the decoupling groove (21) is formed with a groove depth (22) that essentially corresponds to the difference between the maximum diameter (28) and a first diameter (27) of the sensor element (10).

6. The sensor element as recited in claim 2,
wherein the decoupling groove (21) extends essentially in the center between the first end face (11) and the second end face (12) of the sensor element (10).

7. The sensor element as recited in claim 1,
wherein the sealing cone (15) is integrated in the body of the sensor element (10) containing the sensor diaphragm (13).
